(19) United States
(12) Patent Application Publication
(10) Pub. No.: US 2003/0068044 A1
(43) Pub. Date: Apr. 10, 2003

(54) Pilot authentication system

(76) Inventor: Mark E. Nikolsky, Oradell, NJ (US)

Correspondence Address: MARK E. NIKOLSKY, 36 POPLAR AVENUE, ORADELL, NJ, 07649, US

(21) Appl. No.: 09/972,126

(22) Filed: Oct. 6, 2001

(51) Int. Cl. H04K 1/00

(52) U.S. Cl. 380/258

(57) ABSTRACT

A pilot authentication system for commercial and non-commercial aircraft is provided. A processor containing a database of digitized fingerprints of individuals authorized to control a given aircraft is located in the aircraft and in communication with the aircraft's avionics computer. A plurality of sensors, including fingerprint and biometric sensors, sample the fingerprints and biometric information at an individual at the controls of the aircraft. The processor compares the sampled fingerprints to the database of authorized individuals, determining whether an unauthorized individual is at the controls of the aircraft. Using the biometric information, the processor also determines whether a pilot is experiencing physical distress while at the controls of the aircraft. Further, the processor determines whether the aircraft is in motion and is not being controlled by either an authorized pilot or the aircraft's autopilot. In response to either an unauthorized pilot at the controls of the aircraft, physical distress experienced by the pilot, or an unattended aircraft condition, the processor generates a categorized alert signal and transmits same to a ground-based monitoring system. The signal contains information regarding the condition, including a digitized fingerprint of an unauthorized pilot. The signal is processed and alert means at the ground-based monitoring system are activated so that personnel can respond. Additionally, the ground-based monitoring system, in response to an unauthorized pilot at the controls of the aircraft, stores the digitized fingerprint of the unauthorized pilot in a memory system, and alerts law enforcement personnel for corrective action. The ground-based monitoring system includes a master database containing fingerprints of authorized pilots. Both the aircraft-based and ground-based databases can be selectively manipulated to add or delete fingerprints of individuals authorized to control aircraft.

### BACKGROUND OF THE INVENTION

1. Field of the Invention

The present invention relates generally to a system for authenticating pilots of commercial and non-commercial aircraft. More specifically, the invention relates to a pilot authentication and alert system that detects whether an individual is unauthorized to control an aircraft or an authorized pilot is in physical distress, and generates associated warnings to a ground-based alert system.

2. Related Art

In an era of increased air transportation, the need to provide safe air travel is paramount. A variety of adverse conditions can impede safe air travel, including hijackings, passenger disturbances, and physical distress experienced by the pilot. In the case of hijackings, individuals unauthorized to control the aircraft can overpower the pilot and gain control of the aircraft, thereby placing passengers and other individuals in severe jeopardy. Further, a pilot can experience a heart attack or some other type of physical emergency, thereby severely limiting his or her ability to safely control the aircraft. In all of the above-mentioned emergencies, it is crucial for law enforcement and regulatory personnel to be informed of the emergency as quickly as possible, so that appropriate responses thereto can be effected.

In the case of hijackings, it is known in the art for a pilot to alert an air traffic controller by sending a distress signal from the aircraft at the time of the hijacking. Such an alert methodology, however, relies upon the pilot to initiate the alert. If the pilot is physically unable to render such alert, a potentially dangerous situation is left unremedied. Accordingly, the need arises to provide a system that can detect the presence of unauthorized individual, such as a hijacker, at the controls of an aircraft without relying upon a pilot to initiate an alert signal.

What would be advantageous, but has not yet been provided, is a system for authenticating pilots of aircraft and monitoring them during the flight. Specifically, it would be advantageous to provide a system that can monitor the presence of an unauthorized individual at the controls of an aircraft, and quickly alert ground-based personnel of same. It would also be advantageous to provide a system for detecting and alerting ground-based personnel when a pilot has experienced physical distress, or when the controls of an aircraft are left unattended while the aircraft is in flight. The present invention solves the above problems by providing a pilot authentication system that detects the aforementioned conditions and alerts a ground-based monitoring system so that appropriate personnel can be warned and corrective measure implemented.

### OBJECTS AND SUMMARY OF THE INVENTION

It is an object of the present invention to provide a system that can detect the presence of an unauthorized pilot at the controls of an aircraft and alert individuals of same.

It is a further object of the present invention to provide a system that can detect physical distress experienced by a pilot of an aircraft and alert individuals of same.

It is another object of the present invention to provide a system that can detect when the controls of an in-flight aircraft are unattended and alert individuals of same.

It is yet an additional object of the present invention to provide a pilot authentication system that utilizes fingerprint sensors and biometric sensors to detect a variety of alert conditions and generate alert signals in response thereto.

It is another object of the present invention to provide a pilot authentication system that can be remotely programmed to authorize a plurality of individuals to control an aircraft.

It is a further object of the present invention to provide a ground-based monitoring system that can receive alert signals generated by an aircraft-based authentication system and alert ground-based personnel of emergency situations occurring in the cockpit of an aircraft.

It is still another object of the present invention to provide a ground-based monitoring system that alerts law enforcement and administrative agencies of emergencies occurring in the cockpit of an aircraft.

It is yet another object of the present invention to provide a pilot authentication system that utilizes databases of digitized fingerprints to authenticate pilots of aircraft.

It is a further object of the present invention to provide a pilot authentication system that can be easily implemented in existing commercial and non-commercial aircraft.

The present invention relates to a pilot authentication system for commercial and non-commercial aircraft. A plurality of sensors, including fingerprint and biometric sensors, monitor the fingerprints and biometric information of an individual at the controls of an aircraft. An aircraft-based processor analyzes the acquired information and compares same with a digitized fingerprint database of authenticated pilots to determine whether the individual at the controls of the aircraft is authorized to control same. The processor also monitors for physical distress experienced by an authorized pilot, in addition to monitoring the aircraft to determine whether it is being controlled by an authorized pilot or autopilot while in flight. In response to any of these conditions, the processor of the invention generates a categorized alert signal that is sent to a ground-based monitoring system for processing and alerting appropriate personnel. The ground-based monitoring system can remotely monitor and manage the aircraft-based processor, so that personnel can be selectively authenticated and de-authenticated to control the aircraft. The invention includes a secured network connection that can be implemented between the ground-based monitoring system and a law enforcement or administrative agency, so that responsive measures can be quickly implemented by such agencies.

### BRIEF DESCRIPTION OF THE DRAWINGS

These and other features and advantages of the present invention will become better understood with reference to the following detailed description, appended claims, and accompanying drawings, wherein:

FIG. 1 is a block diagram showing component parts of the present invention installed in an aircraft.

FIG. 2 is a flowchart showing processing logic of the aircraft-based system of the present invention.

FIG. 3 is a flowchart showing further processing logic of the aircraft-based system of the present invention.

FIG. 4 is a flowchart showing additional processing logic of the aircraft-based system of the present invention.

FIG. 5 is a block diagram showing a communications protocol utilized by the present invention.

FIG. 6 is a block diagram showing exemplary embodiments of the communications protocol of FIG. 5.

FIG. 7 is a block diagram showing component parts of a ground-based monitoring system according to the present invention.

FIG. 8 is a flowchart showing processing steps of the ground-based monitoring system of the present invention.

### DETAILED DESCRIPTION OF THE INVENTION

The present invention relates to a pilot authentication system, wherein the identity of an individual controlling a commercial or non-commercial aircraft is ascertained and compared to a database of authorized pilots. In the event that an unauthorized pilot is at the controls of the aircraft, the system of the present invention generates a categorized alert, and transmits same to a ground-based monitoring system. The invention also provides a means for detecting pilot physical distress, in addition to an unattended aircraft condition, and alerting the ground-based monitoring system of same. The database of authorized pilots, located in a processor in the aircraft, can be remotely updated and controlled, so that authorized pilots can be selectively added and deleted.

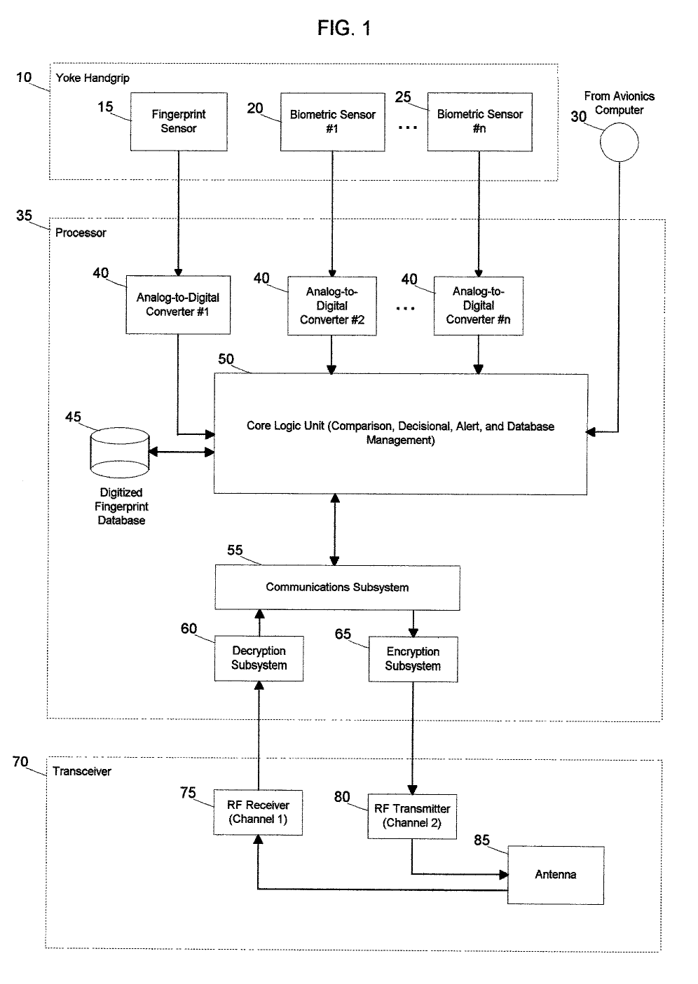

Depicted in FIG. 1 is a block diagram showing component parts the pilot authentication system of the present invention, installed in an aircraft. Initially provided is yoke handgrip 10. Yoke handgrip 10 can be of any design presently known in the art and used to control commercial or non-commercial aircraft. In a preferred embodiment of the invention, a plurality of sensors are disposed in yoke handgrip 10, including fingerprint sensor 15, and at least one biometric sensor 20. Additional biometric sensors 25 can also be included.

Fingerprint sensor 15 can be configured to be installed in yoke handgrip 10 in such a location as to allow for repeated sampling of the fingerprint of an individual whose hands are gripping the handgrip. Further, each of biometric sensors 20, 25 can configured to monitor biomedical information of the same individual, such as heart rate or body temperature. It is to be understood that fingerprint sensor 15 and biometric sensors 20, 25 can be located anywhere proximal to a pilot without departing from the spirit of the present invention. In a preferred embodiment of the present invention, fingerprint sensor 15 and at least one biometric sensor 20 are disposed in areas of the yoke handgrip 10 that are most frequently gripped, thereby allowing for continuous sampling of an individual's fingerprint and heart rate.

The pilot authentication system of the present invention includes a processor 35 connected to sensors 15, 20, 25. Processor 35 contains a plurality of analog-to-digital converters 40, a digitized fingerprint database 45, a core logic unit 50, a communications subsystem 55, decryption subsystem 60, and encryption subsystem 65. Also connected to processor 35 is avionics computer connection 30. Through avionics computer connection 30, processor 35 can acquire avionics information about the aircraft, such as altitude, airspeed, and autopilot status. This information, as will be described in further depth below, assists the processor 35 in determining whether the aircraft is being properly controlled, and whether to transmit an alert signal to a ground-based monitoring system. Core logic unit 50 receives information from the fingerprint sensor 15, and at least one biometric sensor 20, said information being transformed from an analog to a digital form by analog-to-digital converters 40. The information acquired from fingerprint sensor 15 an biometric sensor 20 is utilized by core logic unit 50 to determine whether an authorized pilot is at the controls of the aircraft, and whether the individual is in physical distress.

Further connected to core logic unit 50 is digitized fingerprint database 45. Database 45 contains a series of digitized fingerprints of individuals authorized to control a given aircraft. For example, an airline can program fingerprint database 45 to include a digitized fingerprint of a pilot authorized to fly a particular flight. Additionally, fingerprint database 45 can include fingerprints of other authorized personnel, such as co-pilots and one or more flight attendants. Fingerprint database 45 therefore allows an airline or owner of a particular aircraft to selectively authenticate certain individuals to control the aircraft. Because airlines frequently rotate crews for a given aircraft, fingerprint database 45 can be advantageously re-programmed to include the fingerprints of a particular crew for a particular flight.

Also connected to core logic unit 50 is communications subsystem 55, which is responsible for managing communication between the processor 35 and a ground-based monitoring system. Communications subsystem 55 allocates and assigns radio-frequency channels as needed, and manages decryption subsystem 60 and encryption subsystem 65. Thus, if processor 35 generates an alert signal, communications subsystem 55 dynamically establishes a radio link between the processor 35 and a ground-based system. Once the link has been established, communications subsystem 55 transmits the alert to encryption subsystem 65, which encrypts the alert signal in any manner known in the art. Further, if communications subsystem 55 detects an incoming signal being transmitted from a ground-based system, it activates decryption subsystem 60, which is responsible for decrypting the incoming signal in any manner known in the art. Examples of such incoming and outgoing signals, which will be described in further detail later, include pilot physical distress alerts, unauthorized pilot alerts, unattended aircraft alerts, and incoming database management signals received from a ground-based system.

Information leaving and entering processor 35 is transmitted and received by transceiver 70. Transceiver 70 can be any radio transceiver known in the art, preferably operating in the microwave or near-microwave radio bands. Further, transceiver 70 can form part of a larger, satellite transmission system, wherein transceiver 70 transmits and receives information from a satellite, said information then being transmitted to and received from a ground-based system. In a preferred embodiment of the invention, transceiver 70 effectuates a radio link between processor 35 and a ground-based monitoring system. Transceiver 70 comprises a radio frequency (RF) receiver 75 operating on a first communications channel, and an RF transmitter 80 operating on a second communications channel. Both RF receiver 75 and RF transmitter 80 are connected to a common antenna 85, which propagates outgoing and receives incoming signals. It is to be understood that additional components and configurations can be utilized within transceiver 70 without departing from the spirit of the present invention.

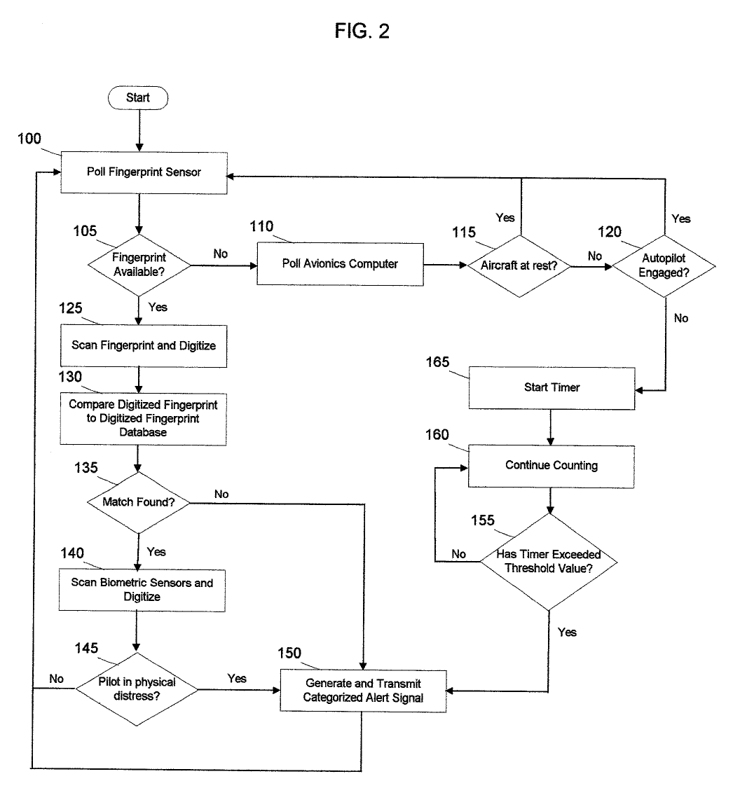

Turning now to FIG. 2, depicted is a flowchart showing control logic of the present invention. As mentioned earlier, core logic unit 50 is responsible for monitoring the fingerprints of an individual whose hands are controlling the aircraft, in addition to the individual's heart rate or other biometric status, and comparing the fingerprints to a database of authenticated fingerprints to determine if the individual is authorized to control the aircraft. Further, core logic unit 50 generates at least one of a series of alert signals in the event that the pilot is either unauthorized, in physical distress, or the aircraft is flying unattended. In a preferred embodiment, the logic depicted in FIG. 2 representing processing achieved by core logic unit 50, is embodied in a software program residing in a compact, dedicated computer system.

Beginning in step 100, fingerprint sensor 15 is polled to determine the status of the sensor. Step 100 invokes step 105, wherein a decision is made as to whether a fingerprint is available at sensor 15. If a fingerprint is available, step 105 invokes step 110, wherein the avionics computer of the aircraft is polled via connection 30 to acquire information about the aircraft. The information acquired includes both the air speed and autopilot status of the aircraft. Additional avionics information can also be acquired. Once the information has been acquired, step 110 invokes step 115. Step 115 examines the acquired avionics information and determines whether the aircraft is at rest. If the aircraft is at rest, step 115 re-invokes step 100, wherein the fingerprint sensor is again polled to acquire fingerprint information. If step 115 determines that the aircraft is not at rest, step 120 is invoked. In step 120, a determination is made as to whether the aircraft's autopilot system is engaged. If a positive determination is made, step 100 is re-invoked in the manner described earlier. If a negative determination is made, step 165 is invoked.

In the event that step 165 is invoked, the system of the present invention has determined that the aircraft is in motion, and that neither a human being nor an autopilot is at the controls. Because of this potentially dangerous condition, a timer is invoked in step 165. The timer continues counting in step 160, and a decision point is reached in step 155. If the current value of the timer has not exceeded a threshold value, step 155 re-invokes step 160 so that the timer can continue counting. However, if the threshold value has been exceeded, step 155 invokes step 150, wherein a categorized alert signal is generated and transmitted.

The threshold value represents the maximum time period that a given owner or operating airline desires to have the aircraft operating without human or autopilot control. This value can be changed according to the owner or operating airline's desires. In a preferred embodiment of the invention, the threshold value is set on the order of minutes, so that an alert signal can quickly be generated. In a further embodiment of the present invention, an audio or visual alert can be activated in the cockpit when the threshold value has been exceeded by the timer and prior to the transmission of an alert signal to the ground-based system.

In the event that step 105 determines that a fingerprint is available at fingerprint sensor 15, step 125 is invoked. In this step, the fingerprint available at the fingerprint sensor 15 is scanned and digitized by one of the plurality of analog-to-digital converters 40. Once the fingerprint is scanned and digitized, step 125 invokes step 130, wherein the scanned digitized fingerprint is compared to the authorized fingerprints stored in digitized fingerprint database 45. Such comparison is not limited to a particular method, and can be achieved by fingerprint comparison algorithms presently known in the art. Once the comparison is made, step 135 is invoked, wherein a determination is made as to whether a matching authorized fingerprint was found in digitzed fingerprint database 45. If a match was not found, step 135 invokes step 150, wherein a categorized alert signal is generated and transmitted. If a match was found, step 135 invokes step 140.

In step 140, at least one biometric sensor 20 is scanned for information and the acquired information digitized. Such information can include, but is not limited to, heart rate or body temperature. Once the information is acquired, step 140 invokes step 145, wherein a determination is made as to whether the pilot is in physical distress. For example, if heart rate information is acquired, the presence of physical distress can be determined if the heart rate exceeds or falls below predetermined rates, thus indicating the possibility of heart attack or death. If step 145, using the acquired biometric information, determines that the pilot is not in physical distress, step 100 is re-invoked and the process described thus far repeated, so that continued monitoring is achieved. If step 145 determines that the pilot is in physical distress, step 145 invokes step 150, wherein a categorized alert signal is generated and transmitted. When step 150 is complete, step 100 is re-invoked so that additional monitoring can occur.

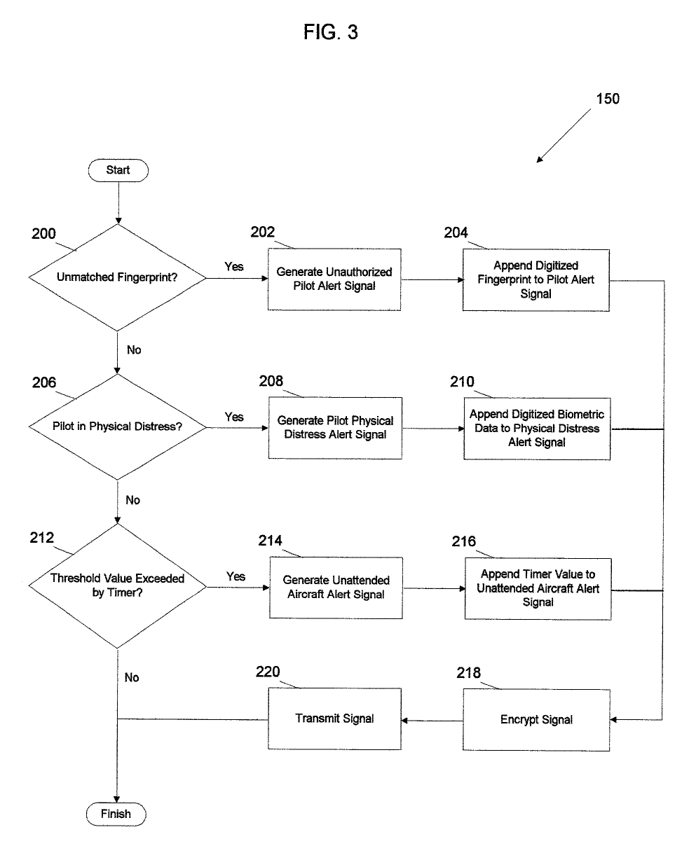

Depicted in FIG. 3 is alert generation and transmission step 150 of FIG. 2 shown in greater detail. As illustrated above, the present invention can detect emergency situations in an aircraft, such as the presence of an unauthorized pilot at the controls of the aircraft, an unattended aircraft in motion, and a pilot in physical distress. Importantly, when one of these conditions occurs, the invention generates a categorized alert signal that is transmitted from the aircraft and received by a ground-based monitoring system, described later in greater detail. The control logic of FIG. 3 shows how such categorized alert signals are generated.

Beginning in step 200, a determination is made as to whether an unmatched fingerprint was detected by the present invention. If a positive determination is made, step 202 is invoked, wherein an unauthorized pilot alert signal is generated. Then, in step 204, the digitized fingerprint scanned from fingerprint sensor 15 is appended to the alert signal. Once the signal has thus been generated, step 204 invokes step 218.

In the event that step 200 determines that an unmatched fingerprint was not detected, step 200 invokes step 206, wherein a second determination is made. If step 206 determines that the pilot is in physical distress, step 208 is invoked, wherein a pilot physical distress alert signal is generated. Then, in step 210, the digitized biometric data (i.e., the pilot's heart rate) is appended to the physical distress alert signal. Once the signal has thus been generated, step 210 invokes step 218.

In the event that step 206 determines that the pilot is not in physical distress, step 206 invokes step 212, wherein a third determination is made. If step 212 determines that the threshold value has been exceeded by the timer, step 214 is invoked, wherein an unattended aircraft alert signal is generated. Then, in step 216, the timer value is appended to the unattended aircraft alert signal. Once the signal has thus been generated, step 216 invokes step 218.

In step 218, the alert signal is encrypted via an encryption algorithm stored in encryption subsystem 65 of FIG. 1. As mentioned earlier, any encryption algorithm known in the art can be used to encrypt the signal. Once encrypted, step 220 is invoked, wherein the signal is transmitted by transceiver 70 to a ground-based monitoring system. Accordingly processing of step 150 then completes.

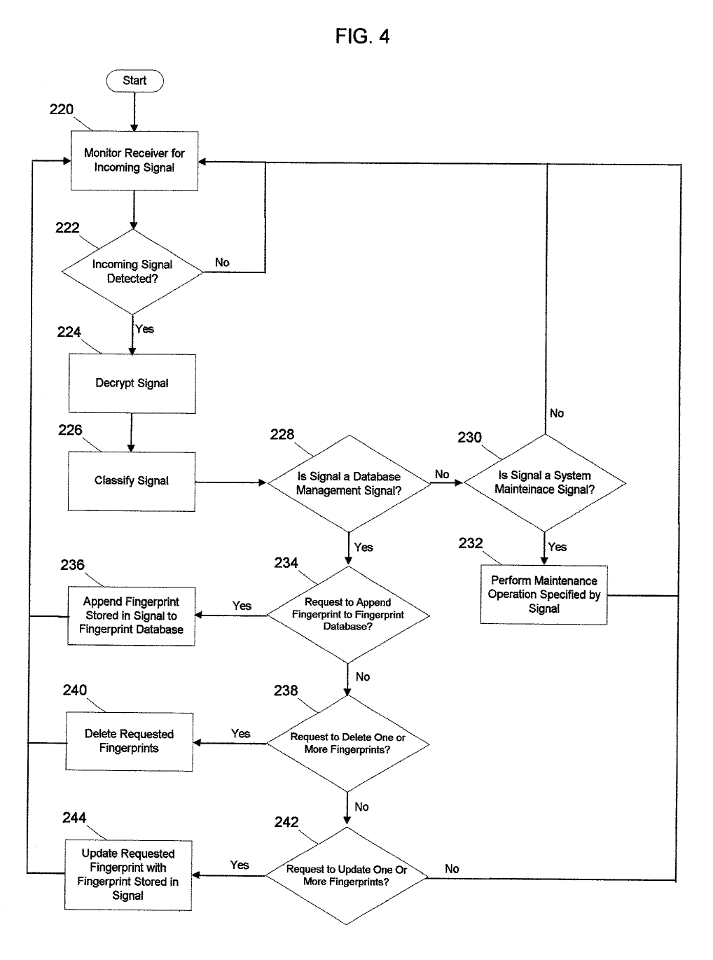

FIG. 4 is a flowchart showing additional processing logic of the present invention, wherein the digitized fingerprint database 45 of processor 35 can be updated and managed by an incoming signal emanating from a ground-based monitoring system. Uploaded fingerprints can be added to the database, and existing ones deleted, so that an aircraft owner or airline can selectively re-program processor 35 to include new digitized fingerprints corresponding to new authorized individuals. Futher, the incoming signal can be used to perform remote maintenance operations on processor 35. Beginning in step 220, the receiver 75 of transceiver 70 is monitored for incoming signals. Then, in step 222, a decision is made if an incoming signal is detected. If an incoming signal is not detected, step 220 is re-invoked so that additional monitoring can occur. If an incoming signal is detected, step 222 invokes step 224.

In step 224, the incoming signal is decrypted by decryption subsystem 60. The decryption process can be achieved by any decryption algorithm presently known in the art. Then, in step 226, the decrypted signal is classified to determine the type of signal received, whether a database management signal or a system maintenance signal. In step 228, a decision point is reached. If the signal is a database management signal, step 234 is invoked. Otherwise, step 230 is invoked, wherein a second decision point is reached. If step 230 determines that the signal is a system maintenance signal, step 230 invokes step 232, wherein maintenance operations specified by the signal can be performed. Examples of such operations include remotely re-booting processor 35 in the event of a failure, or calibrating sensor settings and associated parameters, such as the threshold value described earlier. Once the requested maintenance operation is complete, step 232 re-invokes step 220, so that additional incoming signals can be detected and processed.

In the event that step 228 determines that the incoming signal is a database management signal, step 228 invokes step 234, wherein a determination is made as to whether the database management signal is a request to append an incoming fingerprint to digitized fingerprint database 45. If so, step 236 is invoked, wherein the incoming fingerprint is extracted from the database management signal and added to the digitized fingerprint database 45. Once the update procedure is complete, step 220 is re-invoked, so that additional signals can be monitored. If step 234 results in a negative determination, step 238 is invoked. In step 238, a determination is made as to whether the database management signal is a request to delete one or more fingerprints. If a positive determination is made, step 240 is invoked, wherein the fingerprint or fingerprints requested by the signal are deleted from digitized fingerprint database 45. If a negative determination is made, step 238 invokes step 242.

In step 242, a final determination is made as to whether the database management signal is a request to update one or more fingerprints currently existing in digitized fingerprint database 45. If a positive determination is made, step 244 is invoked, wherein the fingerprint specified by the database management signal is updated with a new fingerprint stored in the signal. Then, step 244 re-invokes step 220, so that additional incoming signals can be detected and processed. If a negative determination is made in step 242, step 220 is re-invoked in the aforementioned manner for additional processing. It is to be understood that additional database management signals not illustrated in FIG. 4 can be included in the present invention without departing from the spirit thereof.

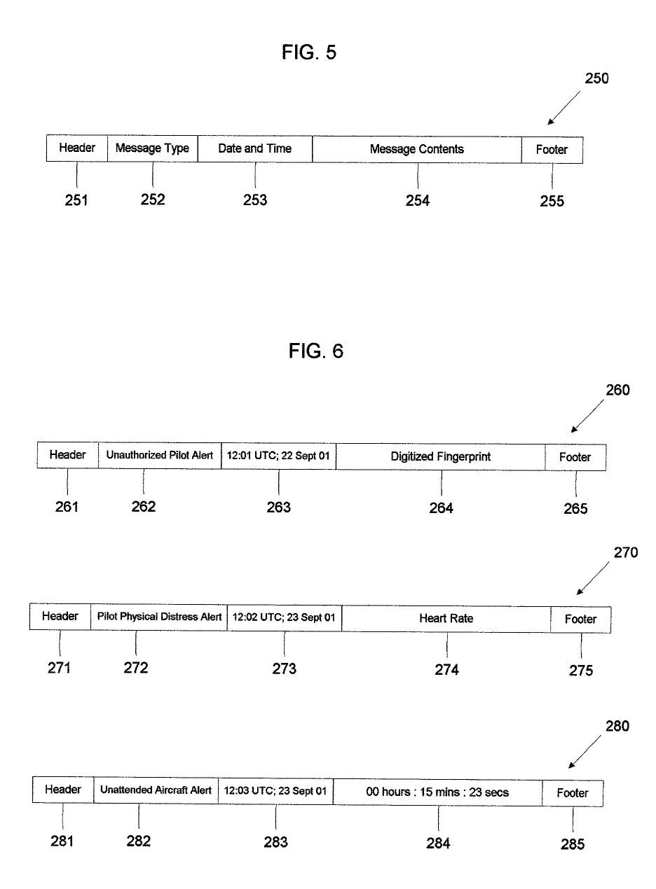

Turning now to FIG. 5, depicted is an exemplary communications protocol of the present invention. The protocol can be used to transmit information from an aircraft-based processing system, described above, and a ground-based monitoring system, described below. Further, the protocol can be used to transmit information from the ground-based system to the aircraft-based processing system. A variety of messages, including the aforementioned categorized alert signals, database management signals, and maintenance operation signals, can be transmitted between the aircraft-based processing system and the ground-based processing system using communications protocol 250. Communications protocol 250 contains fields 251, 252, 253, 254, and 255, each of which correspond to different types of data to be transmitted and/or received. Header field 251 contains identification information about where the message originated. For example, if the message is sent from the aircraft-based processing system, header field 251 would include the flight number of the aircraft. Alternatively, if the message is sent from the ground-based monitoring system, header field 251 would contain an identification number corresponding to the ground-based monitoring system.

Message type field 252 contains an indication of the type of message being transmitted. Examples of such indications include unauthorized pilot alert, pilot physical distress alert, unattended aircraft alert, incoming database management request (i.e., append new fingerprint, delete old fingerprint, update existing fingerprint), and incoming maintenance operation request (i.e., reboot system). Date and time field 253 includes an indication of the date and time corresponding to when the message was created. In a preferred embodiment of the invention, the date and time stored in field 253 are formatted to indicate Coordinated Universal Time (UTC). Message contents field 254 contains payload data to be transmitted or received by the message. Examples of such data include a digitized fingerprint of an unauthorized individual controlling the aircraft, a digitized fingerprint to be uploaded to the aircraft processor as part of a database management operation, a heart rate indication, a body temperature indication, or a timer value. Finally, footer field 255 contains error detection and correction information for the message, such as a Cyclic Receive Check (CRC) indicator. This data can be used to verify that the message has accurately been transmitted or received.

Depicted in FIG. 6 are exemplary embodiments of the communications protocol of the present invention, containing messages corresponding to the various alert signals generated by processor 35 and received by a ground-based monitoring system. For example, message 260 corresponds to an unauthorized pilot alert message generated by processor 35 when an unmatched fingerprint is detected. Header field 261 contains the information described above for FIG. 5, i.e., the flight number of the aircraft generating the message. Field 262 contains message type information indicating that the message is an unauthorized pilot alert. Field 263 contains the date and time, preferably in Coordinated Universal Time (UTC) format, of when the message was generated. Field 264, corresponding to the message contents field described above, contains the digitized fingerprint scanned by fingerprint sensor 15 and processed by processor 35. Advantageously, when the message 260 is transmitted to a ground-based monitoring system, the scanned fingerprint stored therein can be used by law enforcement officials to determine the identity of the unauthorized individual controlling the aircraft. This will facilitate faster law enforcement response in the event of hijackings or other potentially dangerous situations occuring in the cockpit of an aircraft. Finally, footer field 265 contains error-checking code that can be used to verify the integrity of the message 260.

Also depicted in FIG. 6 is message 270, using the same communications protocol described earlier, and configured to transmit a pilot physical distress alert to a ground-based monitoring system. Header field 271 contains the flight number, or other designator, of the aircraft generating the message 270. Field 272 contains message type information indicating that the message 270 is a pilot physical distress alert message. Field 273 contains the date and time of when the message 270 was created. Field 274, corresponding to the message contents field, includes the biometric information, i.e., heart rate or body temperature, acquired by biometric sensor 20, and processed by processor 35. Advantageously, a ground-based monitoring system that receives message 270 can determine the physical state of the pilot controlling the aircraft, including either his or her body temperature or heart rate. Finally, footer field 275 contains the error-checking code described earlier.

Message 280 represents a third embodiment of the communications protocol of the present invention, configured to transmit an unauthorized aircraft alert message to a ground-based monitoring system. Header 281 contains the flight number, or other designator, of the aircraft generating the message 280. Field 282 contains message type information indicating that the message 280 is an unattended aircraft alert message. Field 283 contains the date and time of when the message 280 was created. Field 284, corresponding to the message contents field, includes a time designation indicating the length of time during which the aircraft is unattended. Finally, footer field 285 contains the error-checking code described earlier.

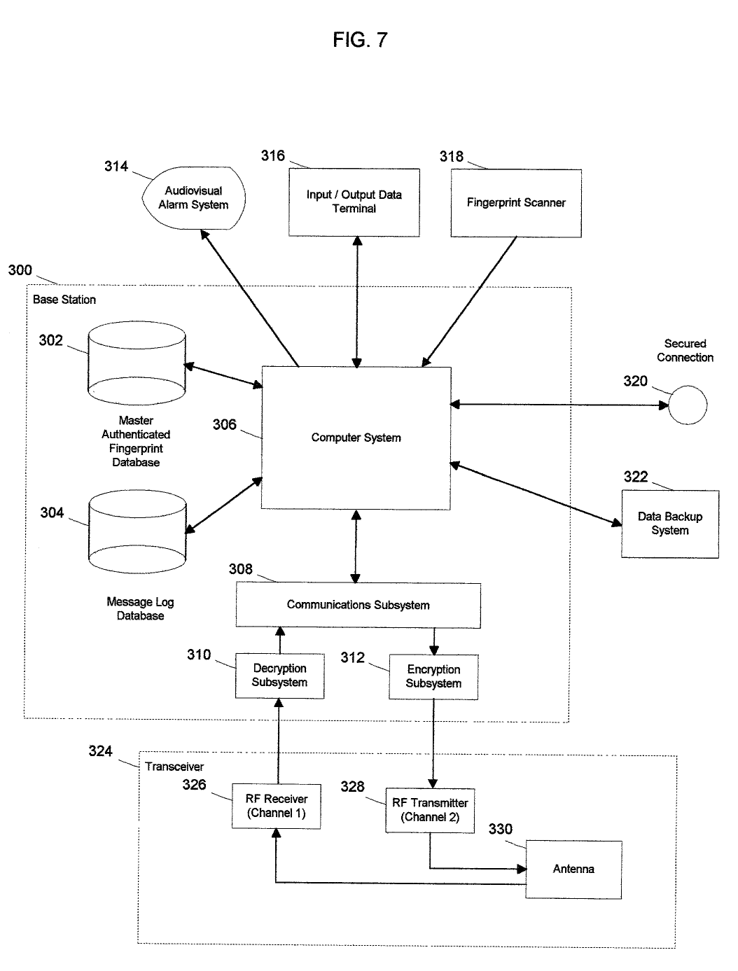

Depicted in FIG. 7 is a block diagram showing the component parts of the ground-based monitoring system of the present invention. The ground-based monitoring system allows for the monitoring of signals generated by processor 35 of the invention, and also allows for ground-based database management and maintenance operations for the present invention. In a preferred embodiment of the invention, the ground-based monitoring system is installed at an air traffic control location, and is in radio communication with processor 35 throughout the duration of flight for an aircraft in which processor 35, and it associated components, are installed. It is to be understood, however, that the ground-based monitoring system can be installed at additional locations without departing from the spirit of the invention.

The ground-based monitoring comprises a central base station, indicated generally at 300, an audiovisual alarm system 314, at least one input/output data terminal 316, transceiver 324, fingerprint scanner 318, secured connection 320, and, optionally, a data backup system 322. Transceiver 324, similar to the transceiver depicted in FIG. 1, allows for radio frequency (RF) communication between aircraft-based processor 35 and ground-based base station 300. Transceiver 324 further comprises RF receiver 326, RF transmitter 328, and antenna 330. Incoming signals are received by antenna 330 and RF receiver 326 and are sent to base station 300 for processing. Also, outgoing signals generated by base station 300 are sent to transmitter 328 and thence to antenna 330, for transmission to an aircraft.

Base station 300 represents the core component of the ground-based monitoring system of the present invention, and is responsible for receiving alert signals, processing same, and alerting ground-based personnel. Further, base station 300 allows ground-based personnel to remotely perform database management and maintenance operations on aircraft-based processor 35, thereby allowing such personnel to update the contents of fingerprint database 45 of processor 35. Base station 300 includes a master authenticated fingerprint database 302, a message log data base 304, computer system 306, communication subsystem 308, a decryption subsystem 310, and an encryption subsystem 312. Decryption subsystem 310 is connected to RF receiver 326 for the purpose of decrypting incoming signals received by RF receiver 326. Similarly, encryption subsystem 312 is connected to RF transmitter 328 for the purpose of encrypting outgoing signals generated by base station 300. Both decryption subsystem 310 and encryption subystem 312 can employ any encryption and decryption methodologies known in the art.

Communications subsystem 308, connected to decryption subsystem 310 and encryption subsystem 312, allocates and assigns radio-frequency channels as needed, and manages decryption subsystem 310 and encryption subsystem 312. Further, communications subsystem 308 is in communication with computer system 306. Computer system 306 can be any digital computer system known in the art, and contains logic for processing incoming alert signals and performing remote database management and maintenance operations for aircraft-based processor 35.

Master authenticated fingerprint database 302, connected to computer system 306, contains a collection of digitized fingerprints of individuals authorized to control a single aircraft or more than one aircraft in a fleet of such aircraft. In a preferred embodiment of the invention, master authenticated fingerprint database 302 contains the digitized fingerprints of airline pilots and co-pilots for a particular airline. The contents of master authenticated fingerprint database 302 can be managed by an individual via input/output data terminal 316, which is connected to computer system 306. Further, the contents of database 302 can be selectively updated by adding additional authorized fingerprints that have either been scanned by fngerprint scanner 318, or uploaded via secured connection 320.

Accordingly, an airline or other operator of the ground-based system of the present invention can selectively manipulate the database 302 of authorized fingerprints. Further, the fingerprint entries of database 302 can be selectively uploaded to aircraft-based processor 35 for storage in fingerprint database 45 thereof. Also connected to computer system 306 is message log database 304, which contains a log of messages received and transmitted by base station 300.

Connected to base station 300 is an audiovisual alarm system 314. Audiovisual alarm system 314 provides an attention-getting, audiovisual means for alerting ground-based personnel when an incoming alert signal is received by base station 300. Audiovisual alarm system 314 can include, but is not limited to, sirens, bells, alphanumeric readout displays, and flashing lights. Input/output terminal 316, also connected to base station 300, allows a ground-based operator to monitor, configure, and maintain both the ground-based monitoring system and the aircraft-based system of the present invention. Fingerprint scanner 318, as mentioned above, allows for additional authorized fingerprints to be sampled for storage in master authenticated fingerprint database 302.

Connected to base station 300 is secured connection 320, which represents a private computer network connection to a law enforcement or administrative agency. Such connection allows base station 300 to send an alert signal not only to those present near the ground-based monitoring system of the invention, but also to a central law enforcement agency so that further action in response to alert signals, and hence, potentially dangerous situations in the cockpit of an aircraft, can be taken. Optionally connected to base station 300 is data backup system 322, which allows the databases 302, 304 and computer system 306 to be backed up for safekeeping.

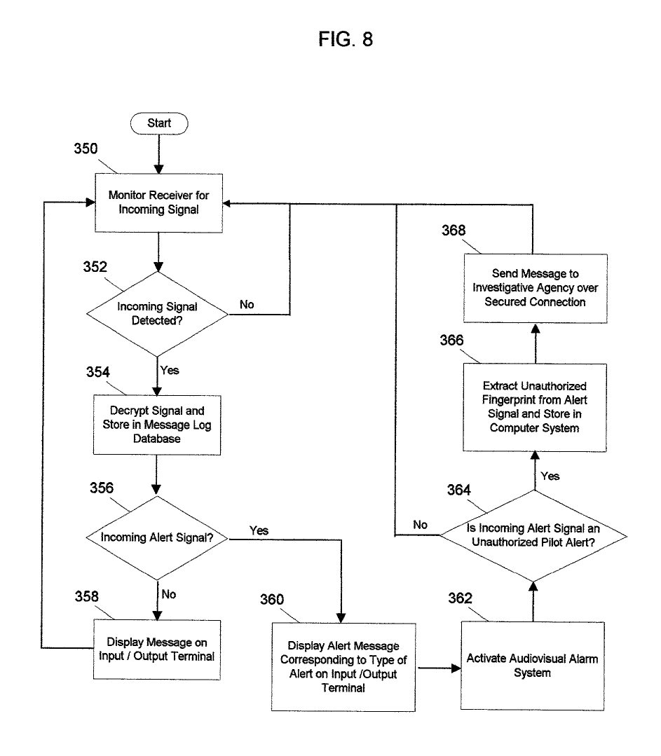

Turning now to FIG. 8, depicted is a flowchart showing processing logic of the ground-based monitoring system of the present invention. Beginning in step 350, receiver 326 is monitored for an incoming signal generated by aircraft-based processor 35. In step 352, a determination is made as to whether an incoming signal has been detected. If a negative determination is made, step 352 re-invokes step 350, so that additional monitoring of incoming signals can occur. If a positive determination is made by step 352, step 354 is invoked, wherein the incoming signal is decrypted by decryption subsystem 310 and a log of the message is stored in message log database 304. Then, step 356 is invoked, wherein a determination is made as to whether the incoming signal is an alert signal. If a negative determination is made, step 358 is invoked, wherein a message corresponding to the incoming signal is displayed in input/output data terminal 316 for review by ground-based personnel. Then, step 350 is re-invoked, so that additional incoming signals can be monitored.

In the event that step 356 determines that the incoming signal is an alert signal, step 360 is invoked. In step 360, an alert message corresponding to the type of alert signal received is displayed on input/output terminal 316 for review by ground-based personnel. Then, step 362 is invoked, wherein the audiovisual alarm system 314 is activated to further alert ground-based personnel of the incoming alert signal. In step 364, a determination is made as to whether the incoming alert signal is an unauthorized pilot alert signal. If a negative determination is made, step 364 re-invokes step 350, so that additional incoming signals can be detected. If a positive determination is made, step 366 is invoked.

In the event that step 366 is invoked, the ground-based monitoring system has detected that an unauthorized pilot is at the controls of the aircraft. In response, step 366 extracts the unauthorized fingerprint from in the incoming alert signal, and stores it in the memory of computer system 306. This allows law enforcement officials to quickly retrieve the fingerprint of the unauthorized individual at the controls of the aircraft, and to take appropriate responsive measures. In step 368, a message is sent over secured connection 320, so that law enforcement or investigative agency is alerted as to the unauthorized pilot alert. After the message is sent, step 368 re-invokes step 350, so that additional incoming messages can be detected.

Having thus described the invention in detail, it is to be understood that modifications and variations thereof can be made by persons of ordinary skill in the art without departing from the scope and spirit of the present invention. What is desired to be protected by Letters Patent is set forth in the following appended claims.

What is claimed is:

1. A pilot authentication system comprising:
a processor located in an aircraft and connected to an avionics computer of the aircraft;
a plurality of sensors connected to the processor and located proximal to the pilot; and
a transceiver connected to the processor,
wherein the processor monitors the plurality of sensors and the avionics computer, determines whether an alert condition is present, and sends an alert signal over the transceiver in response to the alert condition.

2. The system of claim 1, further comprising:
a base station;
a second transceiver connected to the base station; and
an alarm system connected to the base station,
wherein the second transceiver receives the alert signal, the base station processes the alert signal, and the base station activates the alarm system in response to the alert signal.

3. The system of claim 1, wherein the alert condition is triggered by an unauthorized pilot controlling the aircraft.

4. The system of claim 1, wherein the alert condition is triggered by physical distress experienced by the pilot.

5. The system of claim 1, wherein the alert condition is triggered by the aircraft flying unattended.

6. The system of claim 1, wherein the plurality of sensors includes at least one fingerprint sensor.

7. The system of claim 6, wherein the at least one fingerprint sensor scans at least one fingerprint of an individual controlling the aircraft.

8. The system of claim 7, wherein the at least one fingerprint is compared to a database of authorized fingerprints to determine if the pilot is authorized to control the aircraft, said database being located in the processor.

9. The system of claim 8, wherein the database of authorized fingerprints can be remotely updated to selectively add and delete digitized fingerprints of individuals authorized to control the aircraft.

10. The system of claim 1, wherein the plurality of sensors includes at least one biometric sensor.

11. The system of claim 10, wherein the at least one biometric sensor monitors the heart rate of the pilot.

12. The system of claim 10, wherein the at least one biometric sensor monitors the body temperature of the pilot.

13. The system of claim 1, wherein the processor contains a threshold value corresponding to a maximum time period for which the controls of the aircraft can be left unattended.

14. The system of claim 2, wherein the base station further comprises a master database of digitized fingerprints of individuals authorized to control at least one aircraft.

15. The system of claim 14, wherein the master database can be updated to selectively add or delete digitized fingerprints of additional individuals authorized to control at least one aircraft.

16. The system of claim 15, wherein the processor can be updated with records from the master database.

17. A method of authenticating a pilot comprising:
providing a fingerprint database of individuals authorized to control an aircraft;
scanning at least one fingerprint of the pilot at the controls of the aircraft;
comparing the at least one fingerprint to the database of individuals authorized to control the aircraft; and
in response to a negative comparison,
generating an alert signal in a processor in the aircraft; and
transmitting the alert signal from the aircraft to a ground-based monitoring system.

18. The method of claim 17 further comprising:
receiving the alert signal at the ground-based monitoring system;
processing the alert signal; and
activating an alert system in response to the alert signal.

19. The method of claim 17 further comprising:
receiving the alert signal at the ground-based monitoring system;
extracting at least one fingerprint of the pilot from the alert signal;
storing the at least one fingerprint in a storage means at the ground-based system; and
alerting law enforcement authorities.
